(19) United States
(12) Patent Application Publication
(10) Pub. No.: US 2018/0232064 A1
(43) Pub. Date: Aug. 16, 2018

(54) Method for Setting the Position of a Cursor on a Display Screen

(71) Applicants: Matthew Leigh Vroom, San Francisco, CA (US); Brian Neisler, Burlingame, CA (US)

(72) Inventors: Matthew Leigh Vroom, San Francisco, CA (US); Brian Neisler, Burlingame, CA (US)

(73) Assignee: Henge Docks LLC, Arlington, VA (US)

(21) Appl. No.: 15/953,021

(22) Filed: Apr. 13, 2018

Related U.S. Application Data
(63) Continuation of application No. 14/864,198, filed on Sep. 24, 2015.

(51) Int. Cl. G06F 3/038; G06F 3/01; G06F 3/0354

(52) U.S. Cl. CPC G06F 3/038; G06F 3/03543; G06F 3/013

(57) ABSTRACT

Disclosed is a method for positioning a cursor on a display screen connected to a computer, including dividing the display screen into a logical grid having plurality of sections, maintaining a value for each of the plurality of sections, determining an eye-gaze location on the display screen, determining an eye-gaze duration for the eye-gaze location, incrementing a first value of a first section of the plurality of sections corresponding to the eye-gaze location after the eye-gaze duration exceeds a first predetermined threshold, decrementing the first value after a second predetermined threshold, receiving an input signal from a pointing device, the input signal including an X coordinate and a Y coordinate, calculating a net force of gravity due to each value of the plurality of sections, and updating the X coordinate and Y coordinate consistent with the net force of gravity.

### BACKGROUND OF THE INVENTION

This application is a continuation of U.S. application Ser. No. 14/864,198 filed on Sep. 24, 2015 which is a continuation-in-part of pending U.S. application Ser. No. 14/693,688 filed on Apr. 22, 2015 which is a continuation of pending U.S. application Ser. No. 14/693,611 filed on Apr. 22, 2015; all of the aforementioned applications are hereby incorporated by reference.

### FIELD OF THE INVENTION

The embodiments of the invention relate generally to a method for positioning a cursor on a display screen, and more particularly, to a method for positioning a cursor where a user is looking. Although embodiments of the invention are suitable for a wide scope of applications, it is particularly suitable positioning of a mouse cursor on display screen of a personal computer.

### DISCUSSION OF THE RELATED ART

Current methods for determining the location of a cursor on a display screen include manual actions by a user of a computer terminal, such as moving a mouse to position the cursor where the user is looking, for example, at a top corner of the display screen. Other methods for determining the location of cursor on a display screen include shaking or jiggling the mouse to cause rapid movements of the cursor on the display screen so that a user of the computer terminal might notice the rapid movements of the cursor and be able to identify its location. Current methods for positioning a cursor on a display screen include using a mouse or other similar pointing device.

The current methods for determining the location of a cursor on a display screen are limited in that the current methods depend on a user to notice the movement of the cursor. At the same time, the cursor is typically small in comparison to the display screen. Depending on what is currently displayed on the display screen the color of the cursor may be the same color as items shown on the display screen effectively camouflaging the cursor. The combination of a small cursor and effective camouflage can make it very difficult for a user to locate the cursor on a display screen thus frustrating and delaying a user's interaction with a computer terminal. Current methods for positioning a cursor on a display screen are limited in that a user must precisely manipulate the input device, such as a mouse, to position the cursor at the desired location. Precise manipulation of the input device, achievable with current technology, can require time-consuming delicate movements and a high degree of manual dexterity.

### SUMMARY OF THE INVENTION

Accordingly, embodiments of the invention are directed to a method for positioning a cursor on a display screen that substantially obviates one or more of the problems due to limitations and disadvantages of the related art.

An object of embodiments of the invention is to provide aid a user in locating a cursor on a display screen;

Another object of embodiments of the invention is to provide visual indicators of the cursor position;

Yet another object of embodiments of the invention is to provide automatic positioning of the cursor; and

Still another object of embodiments of the invention is to determine when a user is in need of assistance in locating a cursor on a display screen.

Another object of embodiments of the invention is assist a user in positioning a mouse cursor to a desired location.

Additional features and advantages of embodiments of the invention will be set forth in the description which follows, and in part will be apparent from the description, or may be learned by practice of embodiments of the invention. The objectives and other advantages of the embodiments of the invention will be realized and attained by the structure particularly pointed out in the written description and claims hereof as well as the appended drawings.

To achieve these and other advantages and in accordance with the purpose of embodiments of the invention, as embodied and broadly described, a method for determining the position of a cursor on a display screen includes entering a pattern on an input device connected to the computer and displaying an indicator on the display screen identifying the position of the cursor.

In another aspect, a method for setting the position of a cursor on a display screen includes entering a pattern on an input device connected to a computer, determining an eye-gaze location on the display screen, positioning the cursor at the eye-gaze location.

In yet another aspect, a method for setting the position of a cursor on a display screen includes entering a pattern on an input device connected to a computer and positioning the cursor at the predetermined location. The method can further include setting the predetermined location or displaying an indicator on the display screen near the position of the cursor.

In still another aspect, a method for setting the position of a cursor on a display screen includes determining an eye-gaze location on the display screen, receiving a move-intent input, displaying a ghost cursor at the eye-gaze location, receiving a confirmation-intent input, and repositioning the cursor to the eye-gaze location.

In another aspect, a method for setting the position of a cursor on a display screen includes determining an eye-gaze location on the display screen, receiving a move-intent input, displaying a ghost cursor at the eye-gaze location, updating a position of the ghost cursor in accordance with a fine-tuning input, receiving a confirmation-intent input, repositioning the cursor to the eye-gaze location, and hiding the ghost cursor.

In yet another aspect, a method for setting the position of a cursor on a display screen includes determining an eye-gaze location on the display screen, determining a move-intent from a button press state on the mouse, displaying a ghost cursor at the eye-gaze location, updating a position of the ghost cursor in accordance with a fine-tuning input, determining a confirmation-intent from the button press state on the mouse, repositioning the cursor to the position of the ghost cursor, and hiding the ghost cursor.

In another aspect, a method for positioning a cursor on a display screen includes dividing the display screen into a logical grid having plurality of sections, maintaining a value for each of the plurality of sections, determining an eye-gaze location on the display screen, and incrementing a first value of a first section of the plurality of sections corresponding to the eye-gaze location.

In yet another aspect, a method for positioning a cursor on a display screen includes determining an eye-gaze location on the display screen, increasing a value of a gravity well associated with the eye-gaze location, receiving a cursor position from an input device, calculating a net force of gravity due to the gravity well, and updating the cursor position consistent with the net force of gravity.

In still another aspect, a method for positioning a cursor on a display screen includes determining an eye-gaze location on the display screen, determining an eye-gaze duration at the eye-gaze location, increasing a value of a gravity well associated with the eye-gaze location when the eye-gaze duration exceeds a first predetermined threshold duration, receiving a cursor position from an input device, calculating a net force of gravity due to the gravity well, updating the cursor position consistent with the net force of gravity, and decreasing the value of the gravity well after a second predetermined threshold duration.

It is to be understood that both the foregoing general description and the following detailed description are exemplary and explanatory and are intended to provide further explanation of embodiments of the invention as claimed.

### BRIEF DESCRIPTION OF THE DRAWINGS

The accompanying drawings, which are included to provide a further understanding of embodiments of the invention and are incorporated in and constitute a part of this specification, illustrate embodiments of the invention and together with the description serve to explain the principles of embodiments of the invention.

FIG. 1 is a drawing of a display screen, cursor, and input device pattern according to an exemplary embodiment of the invention;

FIG. 2 is a drawing of a display screen, cursor, and location indicator according to an exemplary embodiment of the invention;

FIGS. 3A-3H are drawings of input patterns according to exemplary embodiments of the invention;

FIGS. 4A-4E are location indicators according to exemplary embodiments of the invention;

FIG. 5 is a drawing of a display screen, cursor, and eye-gaze location according to an exemplary embodiment of the invention;

FIG. 6 is a drawing of a display screen, cursor, input device pattern, and location indicator according to an exemplary embodiment of the invention;

FIG. 7 is a process flow chart for determining the position of a cursor on a display screen according to an exemplary embodiment of the invention;

FIG. 8 is a process flow chart for setting the position of a cursor on a display screen according to an exemplary embodiment of the invention;

FIG. 9 is a process flow chart for setting the position of a cursor on a display screen according to an exemplary embodiment of the invention;

FIG. 10 is a process flow chart for setting the position of a cursor on a display screen according to an exemplary embodiment of the invention;

FIG. 11 is a drawing of a display screen and gravity wells according to an exemplary embodiment of the invention; and

FIG. 12 is a drawing of an exemplary gravity well weighting.

### DETAILED DESCRIPTION OF THE PREFERRED EMBODIMENTS

Reference will now be made in detail to the preferred embodiments of the invention, examples of which are illustrated in the accompanying drawings. The invention may, however, be embodied in many different forms and should not be construed as being limited to the embodiments set forth herein; rather, these embodiments are provided so that this disclosure will be thorough and complete, and will fully convey the concept of the invention to those skilled in the art. In the drawings, the thicknesses of layers and regions are exaggerated for clarity. Like reference numerals in the drawings denote like elements.

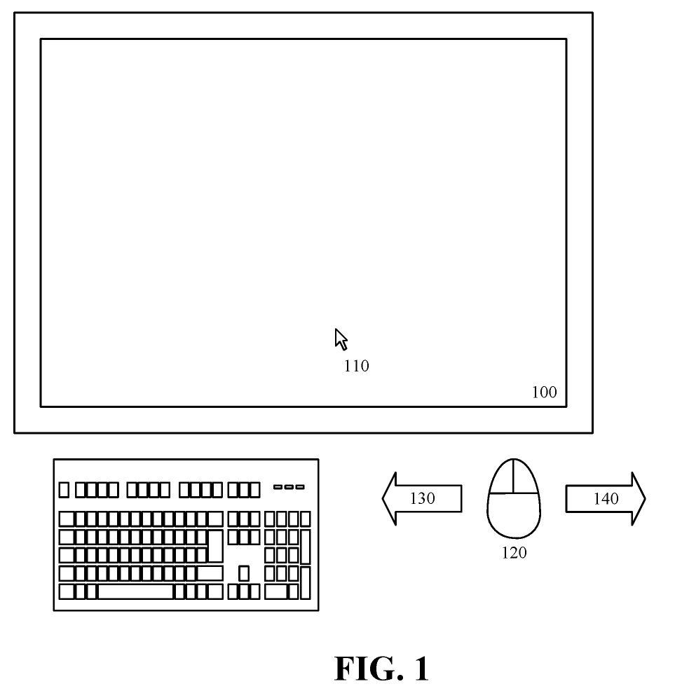

FIG. 1 is a drawing of a display screen, cursor, and input device pattern according to an exemplary embodiment of the invention. As shown in FIG. 1, a method for determining the location of a cursor 100 on a display screen 110 can include entering a pattern 130 and 140 or gesture on an input device 120.

The display screen 110 and the input device 120 can be connected to a computer terminal such as a personal computer or laptop computer (not shown). The computer terminal can include operating system software such as Microsoft Windows or Apple OSX. The operating system software can cause a cursor 110 to be shown on the display screen 100. The position of the cursor 110 can be controlled by an input device 120 such a mouse.

A well-known problem in the field of displaying a cursor on display screen and as further described in the Background of the Invention is that the cursor can become “lost” on the display screen. A user can become frustrated and waste time trying to locate the cursor. Thus, embodiments of the invention include entering a pattern 130 and 140 on the input device 120. In response, the computer terminal can display an indicator on the display screen 100 to aid the user in determining the location of the cursor 110.

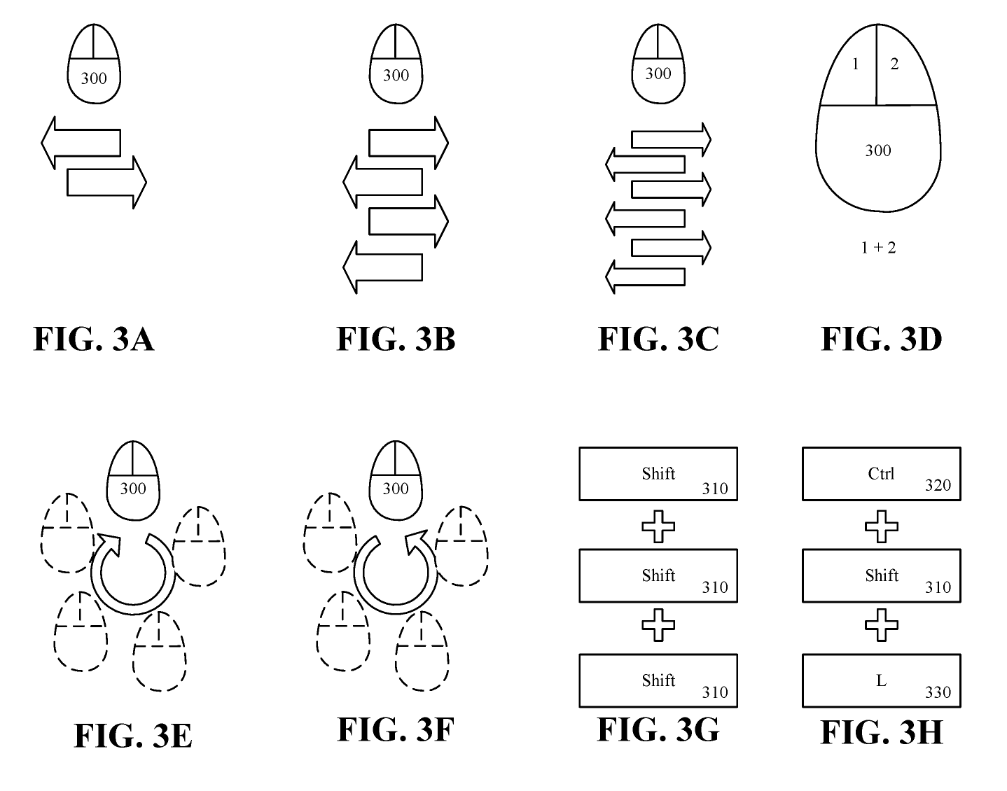

The input pattern of FIG. 1 is illustrated by arrows 130 and 140. The pattern can be, for example, a rapid left-right movement 130, 140. Upon receiving the pattern on the input device, the computer terminal can cause an indicator to be displayed on the screen identifying the location of the cursor 110. In preferred embodiments, the pattern is entered in less than 1000 milliseconds or 500 milliseconds to prevent inadvertently displaying the cursor location indicator through normal use. In other embodiments, the pattern can be sufficiently unique that it would be unlikely to be entered through normal use and thus no time limitation would be needed. Although FIG.1 illustrates a simple left-right pattern, the invention contemplates many patterns can be used as a condition to display the cursor location indicator. Additional patterns include, for example, the patterns illustrated and further described in conjunction with FIG. 3A-FIG. 3H.

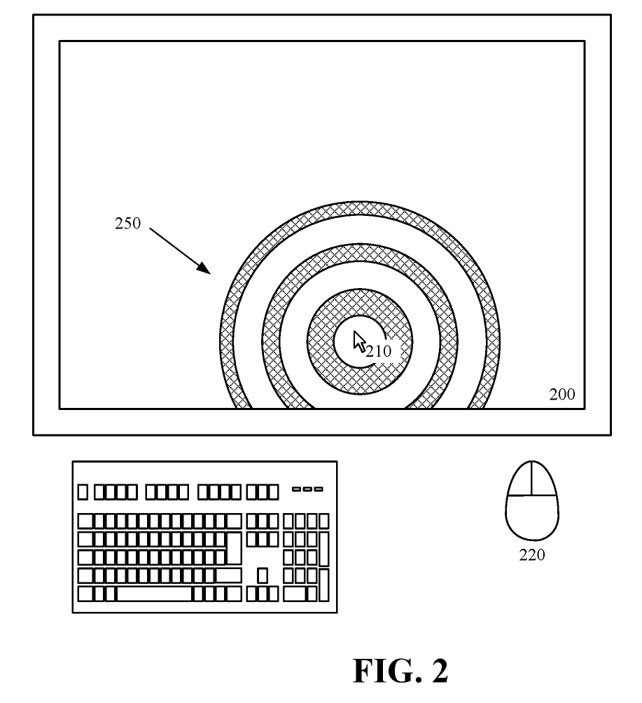

FIG. 2 is a drawing of a display screen, cursor, and location indicator according to an exemplary embodiment of the invention. As shown in FIG. 2, a location indicator 250 can be shown on a display screen 200 at the location of the cursor 210. The location indicator 250 can be shown on the display screen 200 after a pattern is entered on an input device 220. The location indicator 250 can be a graphical element or short animation shown on the display screen 200 near the location of the cursor 210.

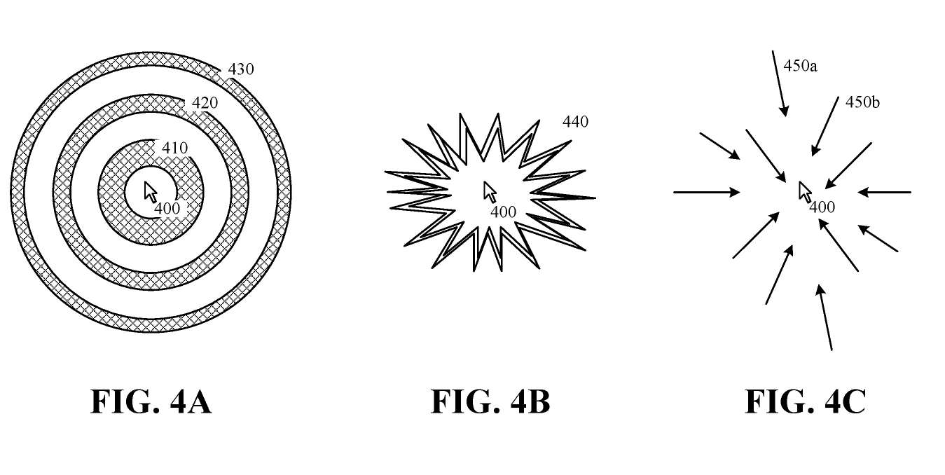

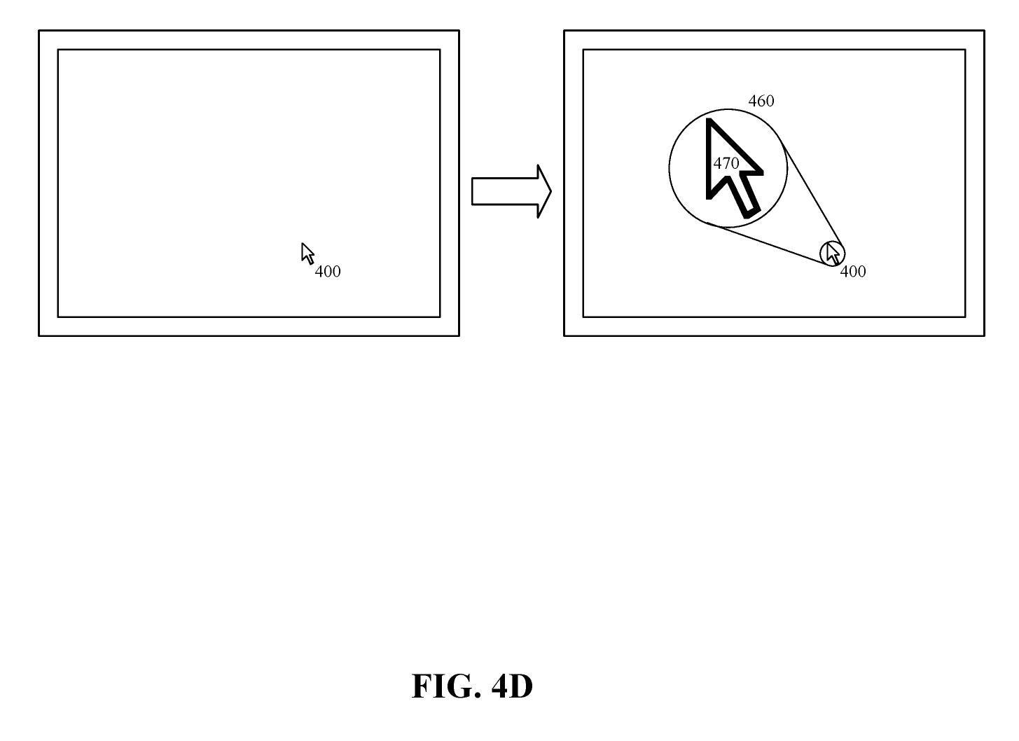

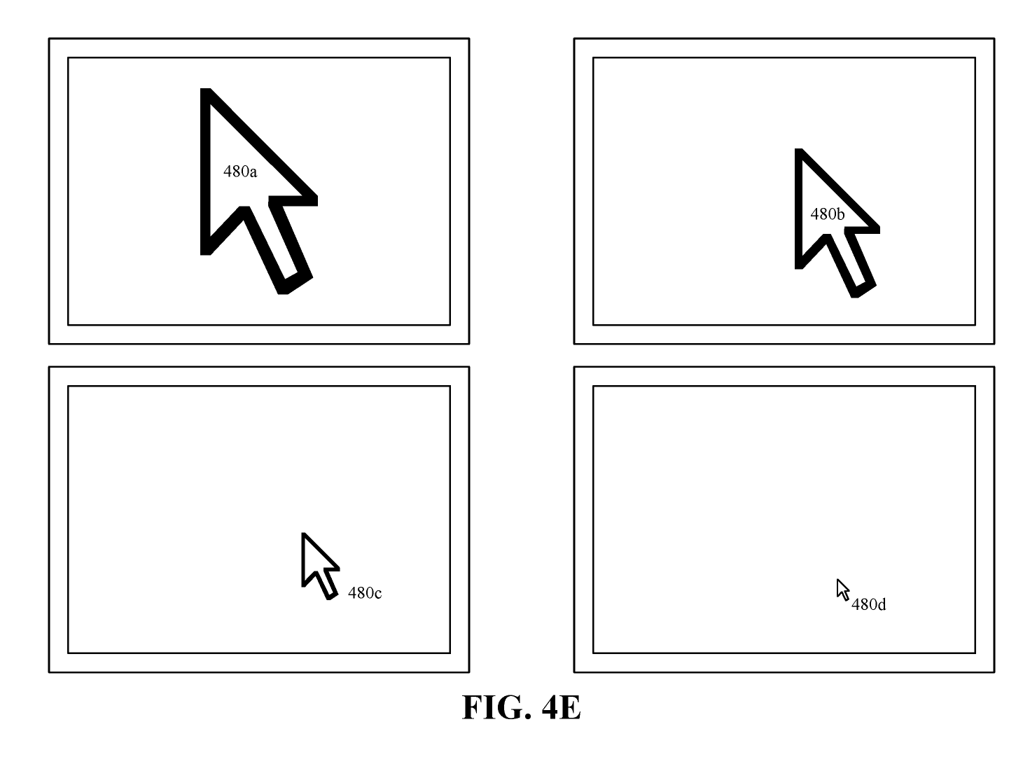

The location indicator 250 can be a short animation of a ripple-effect at the location of the cursor 210. In more detail, the location indicator can be an animation of ripples emanating from the location of the cursor 210 in much the same way that ripples propagate from the impact point when a stone is dropped in water. The diverging nature of the ripple-effect location indicator 250 presents an easily noticeable feature on the display screen 200 that a user can easily trace back to the origin and find the location of the cursor 210. The location indicator 250 can also be a series of concentric rings. Preferred embodiments of the invention include animated location indicators (i.e. location indicators that have movement) because movement is easily perceived by a user of the computer terminal. Although the location indicator 250 of FIG. 2 is described in conjunction with the animated ripple-effect location indicator, other types of location indicators as will be described in further detain in conjunction with FIG. 4A-FIG. 4E.

The location indicator 250 can be shown after a pattern (not shown) is entered on the input device 220. The input device can be, for example, a mouse, a track pad, a track ball, a keyboard, a joy stick, or other computer input device.

FIGS. 3A-3H are drawings of input patterns according to exemplary embodiments of the invention. Although referred to throughout this specification as input patterns, said input patterns could be also be referred to as gestures. As shown in FIG. 3A, a simple input pattern can include a left-right motion on a mouse 300. The computer terminal can be programmed such that if a left-right pattern is entered on the input device according to certain parameters, a location indicator is displayed. The parameters can include, for example, a time parameter wherein the pattern must be entered in under a certain time such as 500 milliseconds. The parameters can include a distance parameter wherein the left-right pattern is measured. For example, the parameter can specify that the left-right pattern must cover 250 pixels left-to-right on the screen and have an up-down variance of no more than 20 pixels. In other embodiments of the invention the distance parameters can be set by a user of the computer terminal in accordance with their personal preferences. The parameters can include an acceleration parameter. The acceleration parameter can specify each movement of the pattern is performed at a certain rate of acceleration. For example, the acceleration parameter can specify that the each of the left and right movements of the pattern must reach an acceleration of 20 centimeters per second. As a second example, the acceleration parameter can specify that the each of the left and right movements of the pattern must reach a deceleration of 20 centimeters per second.

In preferred embodiments of the invention, the parameters can be set to minimize false positives where the location indicator is displayed in response to normal usage when a user did not want it to be displayed. For example, the pattern can be left-right-left-right, a time parameter can be less than 750 milliseconds, a distance parameter can be 125 pixels, an acceleration parameter can be 25 cm/s², and a deceleration parameter can be −25 cm/s². In practical terms, the pattern would be characterized by four cycles of rapid acceleration and deceleration of the input device consistent with a vigorous shaking of the input device. This vigorous shaking can be uncommon user behavior and can be consistent with user frustration such as when a user cannot find the cursor. In response to the user frustration as characterized by the input pattern, the invention can display a location indicator thus addressing the source of user frustration as soon as it arises.

FIG. 3B is an exemplary input pattern characterized by a right-left-right-left pattern. FIG. 3C is an exemplary input pattern characterized by a right-left-right-left-right-left pattern. FIG. 3D is an exemplary input pattern characterized by a simultaneous press of both buttons on the input device 300. The input pattern can include other combination of button presses on the input device. Embodiments of the invention include a single dedicated button on the input device that causes the invention to display the location indicator. FIG. 3E is an exemplary input pattern characterized by a clockwise movement of the input device. The input pattern can include one or more clockwise movements of the input device. FIG. 3F is an exemplary input pattern characterized by a counter-clockwise movement of the input device. The input pattern can include one or more counter-clockwise movements. The input pattern can include a clockwise movement followed by a counter-clockwise movement.

FIG. 3G is an exemplary input pattern characterized by successive button presses on a keyboard input device. In the example of FIG. 3G, pressing the “Shift” three times in a row can activate the location indicator of the invention. FIG. 3H is an exemplary input pattern characterized by a simultaneous button presses on a keyboard input device. In the example of FIG. 3H, pressing the “Ctrl”, “Shift”, and “L” buttons on a keyboard input device can activate the location indicator of the invention.

FIGS. 4A-4E are location indicators according to exemplary embodiments of the invention. As shown in FIG. 4A, the location indicator can be a ripple-effect animation as described in conjunction with FIG. 2. The ripple-effect animation can originate at the cursor 400, and propagate outwards as one or more ripples 410, 420, and 430.

FIG. 4B is a star-burst style animated location indicator. The star-burst style location indicator 440 can be a short animation that appears as explosion at location of the cursor 400.

FIG. 4C is a converging-graphic style animated location indicator. The converging-graphic style location indicator 450a and 450b can be graphical elements that originate at the edges of the display screen and converge at the location of the cursor 400. The graphical elements can be arrows 450a and 450b that move and point to the cursor.

FIG. 4D is a zoom style animated location indicator shown as a series of successive display screens. In the first display screen on the right, the cursor 100 is in its normal state as determined by the operating system of the computer terminal. After an input pattern is entered, a zoom-style detail inset 460 having an enlarged cursor 470 can be displayed. The inset 460 can include leader lines indicating the position of the cursor 400.

FIG. 4E is a drop-in style animated location cursor shown as a series of successive display screens. The drop-in style animated location cursor can show a visual impression of the cursor being close to a user viewing the display screen by enlarging the cursor 480a to cover the entire display screen. The cursor can become progressively smaller 480b and 480c to appear as if the cursor is moving away from the user into the display screen. The progressively smaller cursors displays can converge on or become the actual, normal sized cursor 480d.

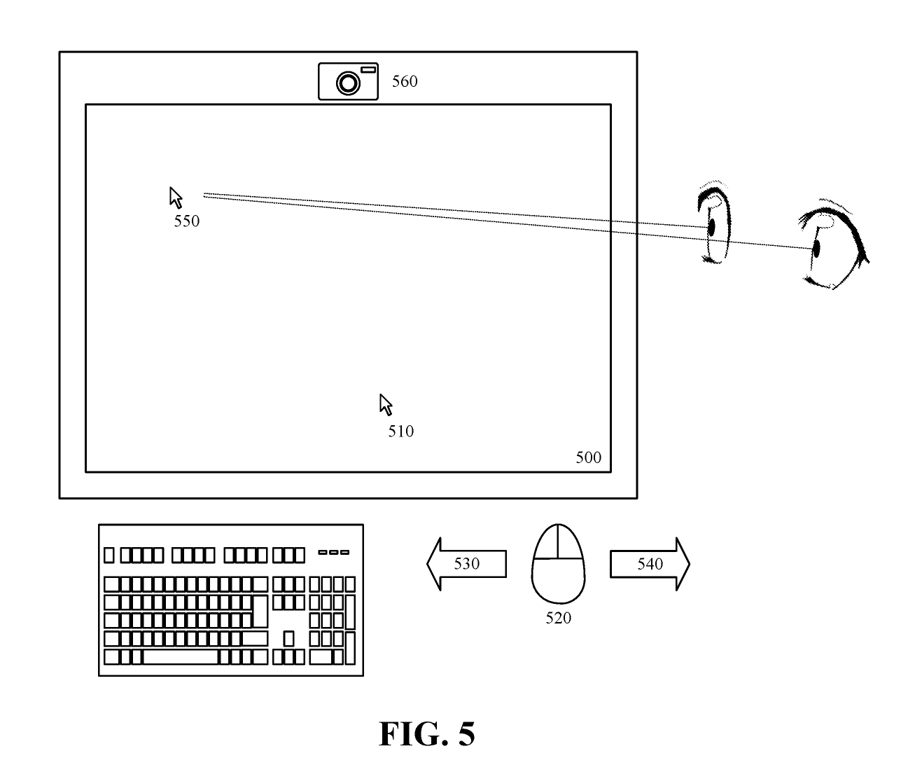

FIG. 5 is a drawing of a display screen, cursor, and eye-gaze location according to an exemplary embodiment of the invention. As shown in FIG. 5, embodiments of the invention can include a camera 560 facing a user of a computer terminal. Together, the camera and the computer terminal can use methods known in the art to determine the location 550 on the display screen 500 a user is looking. See e.g. U.S. Pat. Nos. 5,583,795; 5,231,674; 5,644,642; and 5,471,542 the entirety of which are hereby incorporated by reference. The cursor 510 can initially be disposed at position that is unknown to the user. The user desires to know the location of the cursor 510 and enters a pattern 530, 540 on the input device 520. Upon entering the pattern 530, 540, the invention can use the camera 560 to determine the eye-gaze location 550 on the display screen 500 that the user is looking. The invention can then reposition the cursor 510 at the eye-gaze location 550. The pattern can be an expression of intent to move the cursor location to the eye-gaze location. In other words, entering the pattern can be a move-intent event. Other events can be a move-intent events, such clicking and holding on an item while looking at the trash. Upon releasing the click, the item can be moved to the trash. Certain changes in eye-gaze can be a move-intent event. For example, while reading a web-page, when the eye-gaze reaches the bottom of the screen and then shifts to a scroll bar, the change of gaze from the bottom of the screen to the scroll bar can be an expression of intent to move the cursor to the scroll bar. The user's intent to move the cursor to the scroll bar can be confirmed by clicking and holding. Upon releasing the click, the cursor can return to its previous position.

It is known in the art that eye-gaze determination is only an approximate measure of location and that eye-gaze determination has some degree of imprecision. Thus embodiments of the invention further include fine tuning the eye-gaze location with post-pattern adjustments. In practice, the method of the invention includes the concept of a real cursor 510 and a ghost cursor at the eye-gaze location 550. The ghost cursor can be displayed in a different color or style to differentiate between the real cursor and the ghost cursor. When the pattern is entered, the ghost cursor can be displayed at the eye-gaze location 550. The location of the ghost cursor can then be fine-tuned using the input device. When the fine tuning is finished, the real cursor 510 can be positioned at the fine-tuned location of the ghost cursor.

Completion of the fine tuning step of the ghost cursor can be indicated by a variety of criteria. For example, fine tuning can be completed after a certain amount of time has elapsed such as 1 second. Fine tuning can be completed after the input of a second pattern on the input device such as a button press. In preferred embodiments of the invention, the input pattern can be the press of a dedicated button on a mouse. Upon depressing the button, the ghost cursor can be positioned at the eye-gaze location. While holding the dedicated button, the position of the ghost cursor can be fine-tuned using the input device. Upon releasing the dedicated button, the real cursor can be repositioned at the location of the fine-tuned ghost cursor. The ghost cursor can thereafter be removed from the display screen.

The embodiment of the invention described in FIG. 5 is particularly useful in addressing the problem of the unknown position of the cursor because a user does not have to search for a cursor. Instead, the cursor is positioned where a user is already looking in response to a move-intent event such as a pattern on an input device.

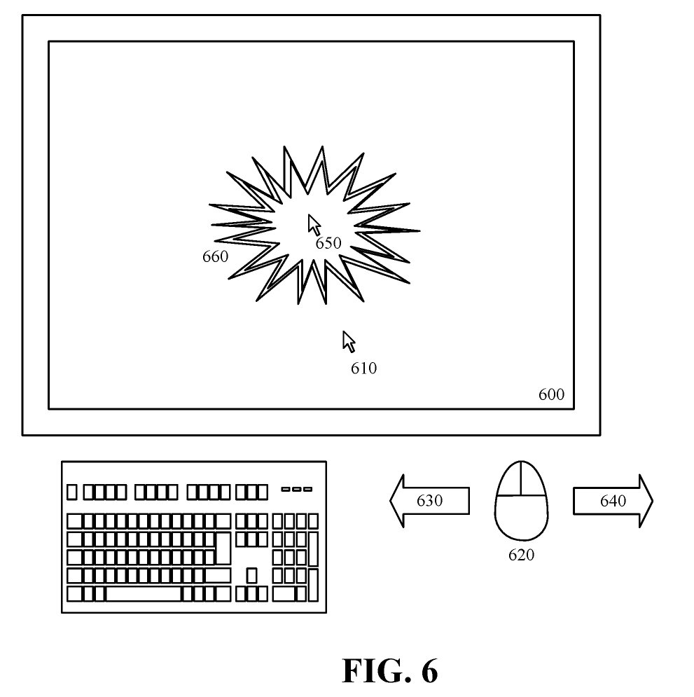

FIG. 6 is a drawing of a display screen, cursor, input device pattern, and location indicator according to an exemplary embodiment of the invention. As shown in FIG. 6, embodiments of the invention include a display screen 600, a cursor 610, an input device 620, a pattern 630, 640, a new cursor location 650, and a location indicator 660. As shown in FIG. 6, a pattern 630, 640 can be entered on the input device 620. The pattern 630, 640 can be, for example, a left movement 630 followed by a right movement 640 on the input device 620, in this case a mouse. Many types of input patterns are contemplated by this invention as more particularly described in conjunction with FIG. 3A-FIG. 3H. The pattern 630, 640 might be entered by the user when the user is searching for the location of the cursor 610. The cursor 610 might be hard to see, camouflaged by other things on the display screen 600, or at the extents of the display screen 600. Upon entering the pattern the invention can reposition the cursor at new cursor location 650 in the middle of the screen. In preferred embodiments of the invention, after repositioning the cursor at new cursor position 650, a location indicator 660 can be displayed to further aid a user in identifying the location of the cursor.

The new cursor position 650 can be any location on the display screen 600, but the new cursor position is commonly set as a standing preference by a user of the computer terminal. For example, the new cursor position 650 can be preset to be the center of the display screen 600. In practice, when a user desires to locate the cursor 610, the user can enter the pattern 630, 640 and the cursor 610 will be repositioned at the predetermined new cursor location 650 at the center of the screen. In this way, a user of a computer terminal does not need to search for the cursor 610. Instead, the cursor is repositioned by the invention to be at a predetermined location such as the middle of the display screen 600 or other predetermined location set according to user preference.

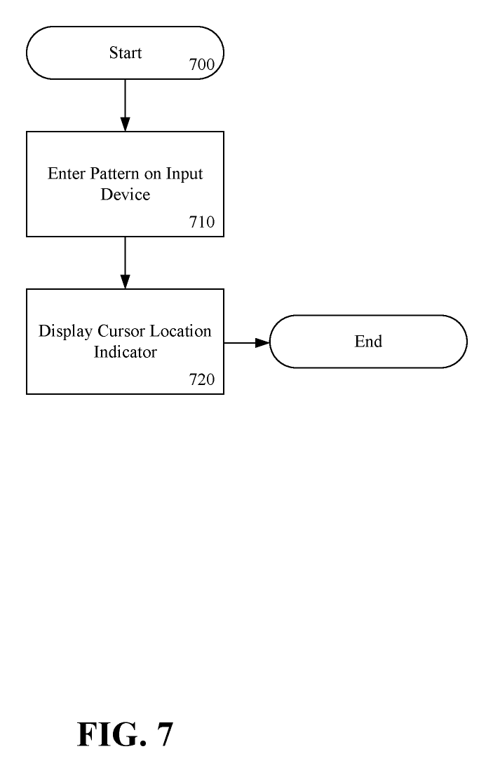

The methods and processes of the inventions will now be described in more detail with reference to the process flow charts of FIG. 7-FIG. 10.

FIG. 7 is a process flow chart for determining the location of a cursor on a display screen according to an exemplary embodiment of the invention. As shown in FIG. 7, a process for determining the location of a cursor on a display screen includes entering a pattern on an input device 710 and then displaying a cursor location indicator 720 at the location of the cursor. In more detail, a user can enter a pattern on an input device, such as a mouse. The pattern can be a predetermined set of input movements, for example, left-right-left. Exemplary patterns include the patterns disclosed in conjunction with FIG. 3A-FIG. 3H. Upon receiving the pattern, the invention can cause a location indicator to appear on the screen proximate to the cursor location so that a user of the computer terminal can easily locate the cursor. The location indicators can be, for example, the location indicators shown and described in conjunction with FIG. 4A-FIG. 4E.

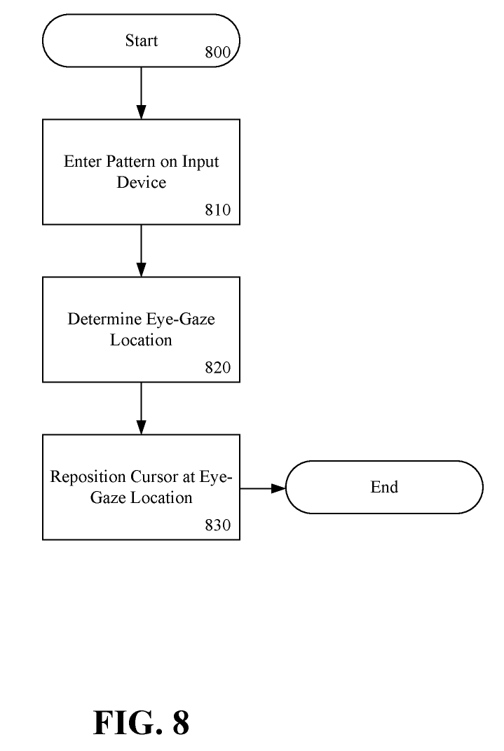

FIG. 8 is a process flow chart for setting the position of a cursor on a display screen according to an exemplary embodiment of the invention. As shown in FIG. 8, a process for setting the position of a cursor on a display screen includes entering a pattern on an input device 810, determining an eye-gaze location of a user of the computer terminal 820, and repositioning the cursor at the eye-gaze location 830. The pattern can be a predetermined set of input movements, for example, left-right-left. Exemplary patterns include the patterns disclosed in conjunction with FIG. 3A-FIG. 3H. Upon receiving the pattern, the invention can determine the eye-gaze location of a user of the computer terminal. The invention can then reposition the cursor at the eye-gaze location. In this, way the user of the computer terminal is saved the frustration and hassle of locating the cursor because the cursor is reposition where the user is already looking.

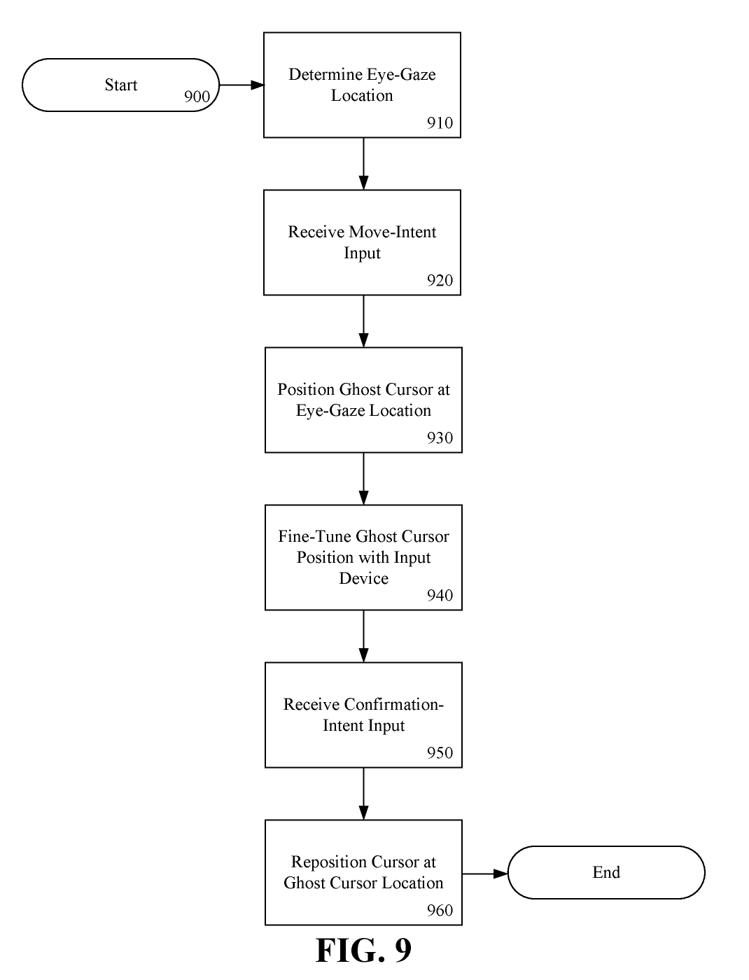

FIG. 9 is a process flow chart for setting the position of a cursor on a display screen according to an exemplary embodiment of the invention. As shown in FIG. 9, the process for setting the position of a cursor on a display screen includes determining the eye-gaze location 910, receiving a move-intent input 920, positioning a ghost cursor at the eye-gaze location 930, fine-tuning the position of the ghost cursor with the input device 940, receiving a confirmation intent input 950, and repositioning the cursor at the ghost cursor location 960.

In more detail, in step 910, the eye-gaze location of a user of a computer terminal can be determined according to methods know in the art. The determining of the eye-gaze location of a user of a computer terminal can be a continual process and does not need to manifest as a single step or necessarily be performed in the sequence described herein. In step 920, the invention can receive a move-intent input. The move-intent input can be calculated or determined based on user actions. For example, an input device such as a mouse can have a button for expressing intent. Upon pressing the button intent can be expressed, and upon releasing the button intent can be confirmed. After determining the eye-gaze location 910 and receiving the move-intent input 920, the invention can position a ghost cursor at the eye gaze location 930.

This invention introduces the concept of a ghost cursor. The “real” cursor is the cursor that corresponds with the input device, such as a traditional mouse. The ghost cursor is a cursor that corresponds with the eye-gaze location. In step 940, a user can optionally fine-tune the position of the ghost cursor with the input device such as the mouse. Fine-tuning can be required because eye-gaze technology at the consumer level is an approximate science. It is contemplated that improvements in eye-gaze technology will obviate the need for this fine-tuning step 940. In step 950, the invention receives a confirmation-intent input. The confirmation-intent input can signify that the user has completed the fine-tuning of the ghost cursor or is otherwise satisfied with the ghost cursor position. In the example of an intent button on a mouse, confirmation-intent can be signified by releasing the intent button. In step 950, after receiving the confirmation-intent input, the invention can reposition the cursor at the location of the ghost cursor. In this way, the user has indicated to the invention that the user desires to move the cursor to the eye-gaze location, fine-tuned the location, and then confirmed the location before the cursor is moved.

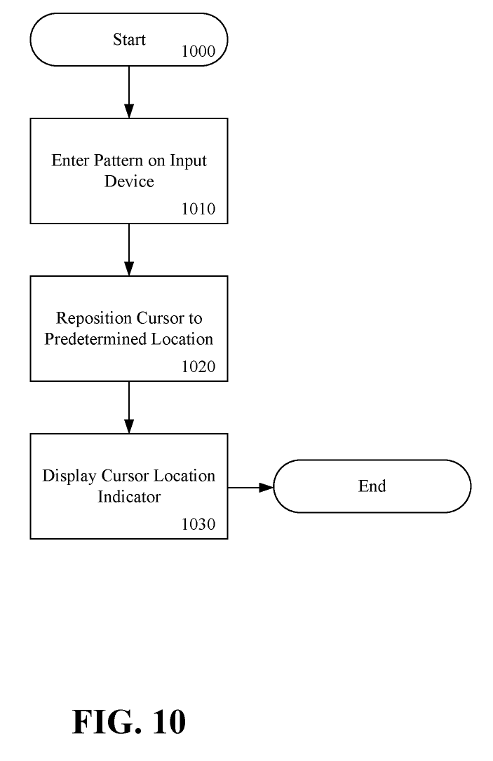

FIG. 10 is a process flow chart for setting the position of a cursor on a display screen according to an exemplary embodiment of the invention. As shown in FIG. 10, a process for setting the position of a cursor on a display screen includes entering a pattern on an input device 1010, repositioning the cursor to a predetermined location 1020, and displaying a cursor location indicator 1030. The pattern of step 1010 can be a predetermined set of input movements, for example, left-right-left. Exemplary patterns include the patterns disclosed in conjunction with FIG. 3A-FIG. 3H. Upon receiving the pattern, the invention can cause the cursor to be moved to a predetermined location such as the middle of the display screen or other predetermined location in accordance with a user preference. In step 1030, the invention can display a location indicator proximate to the cursor location so that a user of the computer terminal can easily locate the cursor. The location indicators can be, for example, the location indicators shown and described in conjunction with FIG. 4A-FIG. 4E.

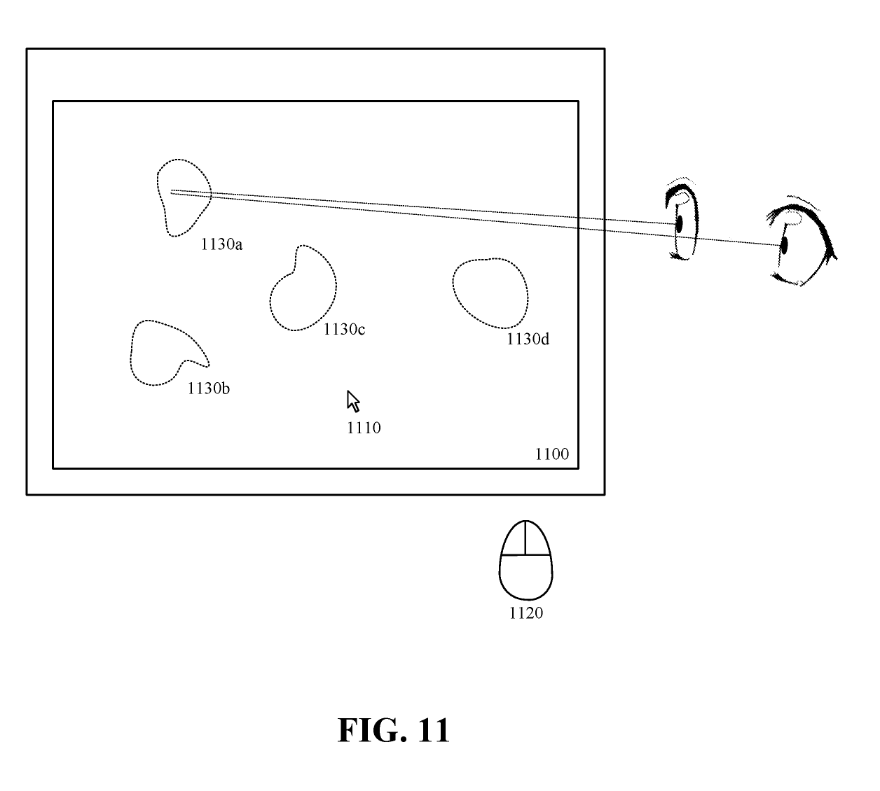

FIG. 11 is a drawing of a display screen and gravity wells according to an exemplary embodiment of the invention. As shown in FIG. 11, embodiments of the invention can include a display screen 1100, a mouse cursor 1110, a mouse 1120, and gravity wells 1130a-1130d.

The display screen 1100 can be attached to a computer (not shown). The display screen 1100 can display, for example, the desktop computing environment (not shown) of a computer operating system, such as Microsoft's Windows. The mouse cursor 1110 can be a graphical display indicator on the display screen 1110. The mouse cursor 1110 can be used to select or interact with elements of the computer operating system such as icons, windows, and buttons. The mouse 1120 can control the mouse cursor 1110 such that movements of the mouse 1120 are replicated in substantial part by corresponding movements in the mouse cursor 1110.

The gravity wells 1130a-1130d can represent areas on the display screen 1100 that a user has gazed upon. Gravity wells, generally, can represent something that a user of the computer is looking at and thus, something that the user would be likely to select with the cursor. Eye gaze location can be determined by methods that are well known in the art. When using the mouse 1120 to move the cursor 1110, the cursor can “snap” into gravity wells. For example, in most instances, the motion of the cursor 1110 can directly correspond to movements of the mouse 1120. However, as the cursor 1110 approaches a gravity well, the gravity well can “pull” the cursor into the gravity well.

The above described gravity well behavior is desirable because a user of a computer terminal that desires to interact with an object on the display screen will commonly first look at the desired area, then attempt to move the mouse cursor to that area. Because the user's first action is to look at the desired location, the gravity well can assist the user in quickly and precisely positioning the cursor at the desired location.

Gravity wells can be temporal in nature. For example, a user will commonly look at a location on the display screen before attempting to move the mouse cursor to that location. The user, however, is unlikely to desire to move the mouse cursor to a location they looked at very far in the past. In the example, of a web browser, a user may look at a scroll bar and then move the cursor to the scroll bar to scroll the open window. Next, the user may look at the “X” button to close the browser, and then move the mouse to close the browser window. In this example, because the user most recently looked at the “X” rather than the scroll bar, the “X” could have stronger a strong gravity well than the scroll bar. After some time, the gravity well on the scroll bar could fade completely. Accordingly in embodiments of the invention, the strength of a gravity well can fade or decay with over time. In preferred embodiments of the invention, the decay time can be five to thirty seconds. The decay time can be set by a user in accordance with a user's preferences.

As the mouse cursor 1110 approaches a gravity well 1130a-1130d, the normal movement of the mouse can be disrupted by the gravity well, thus pulling the cursor towards the center of the gravity well. The effect of the gravity well can be to gently pull the cursor, but not so strong as to over power the will of a user in the event of a false positive. In the example, of FIG. 11, a user that desires to move the mouse cursor 1110 to the approximately eye-gaze location of gravity well 1130a would be likely to cross the gravity well 1130c. As the user moves the mouse cursor past gravity well 1130c in the direction of 1130a, the path of the mouse cursor 1110 can deflect towards the gravity well 1130c. However in this instance, the user desires to position the cursor 1110 at the approximate location of gravity well 1130a. Thus, as the mouse cursor 1110 passes gravity well 1130c, and the path of the mouse cursor deflects towards gravity well 1130c, the user continues to move the mouse cursor towards gravity well 1130a thus overcoming the pull of gravity well 1130c.

The gravity wells 1130a-1130d can be invisible to a user of the computer terminal although the effect of their respective gravity can be apparent when the mouse cursor approaches a gravity well.

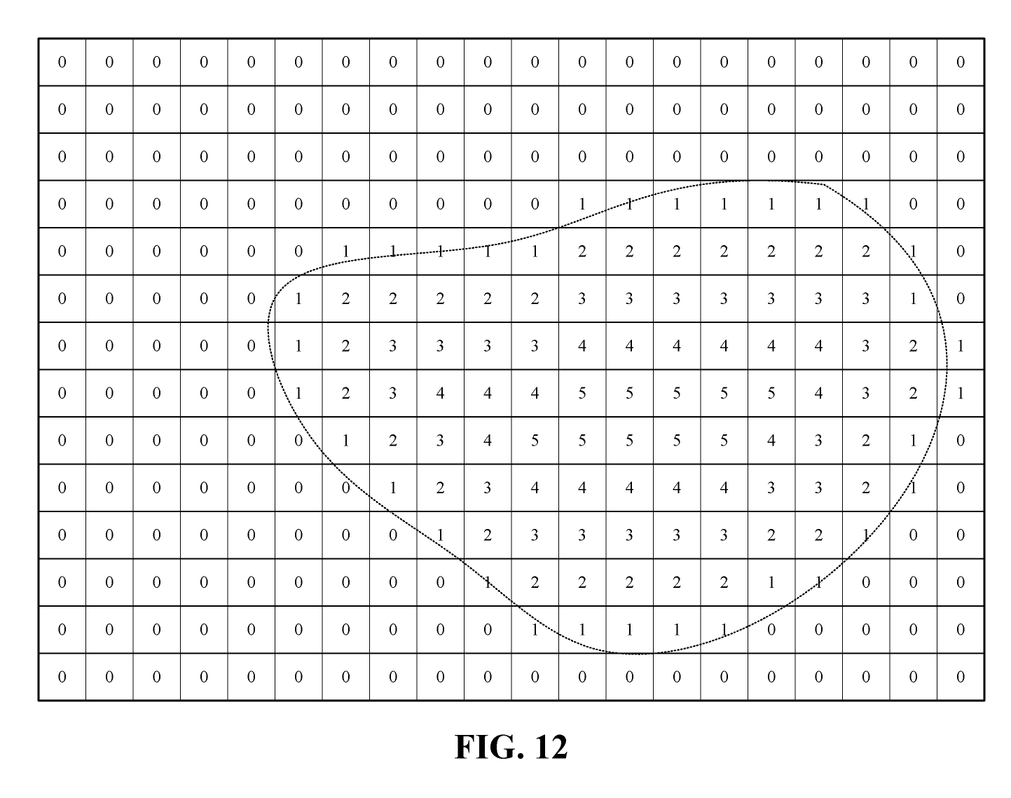

FIG. 12 is a drawing of an exemplary gravity well weighting. As shown in FIG. 12, a display screen can be divided into a grid. Although a grid is shown in FIG. 12, it should be appreciated that the grid is a logical structure and need not be displayed on the screen. Each square of the grid can be assigned a weighting e.g. 0-5. Initially, each square can be assigned a weighting of 0 indicating no gravity. A program can track the eye-gaze location of a user. When an eye-gaze is detected on a particular area of the grid, the program can increment the weighting of the area, e.g. 0 becomes 1, 1 becomes 2, and so on. In preferred embodiments incrementing occurs after an eye-gaze of a particular duration, for example, 100, 250, 500, 750, or 1000 milliseconds. In other embodiments incrementing occurs upon eye-gaze durations on a particular area of at least 100 milliseconds. Increased weighting can indicate increased gravity and the likelihood that a user will attempt to interact with the area where the gravity well is forming.

At intervals, the program can decrement the weighting of all squares of the grid. Decrementing can indicate the passage of time. Thus, old gravity wells fade as time passes and a user is less likely to desire to select something viewed long ago. In preferred embodiments of the invention, decrementing can occur in intervals that are multiples of the eye-gaze duration. For example, if the eye-gaze duration is 100 milliseconds, the decrementing interval can be a multiple thereof, for example, five times or 500 milliseconds. The decrementing interval can be ten times the eye-gaze duration. The decrementing interval can be at least two times the eye-gaze duration.

Programmatically, gravity can be effected on a computer by intercepting input signals from an input device and changing the input signals based on the gravity. For example, assume an initial point A and a desired point B. A and B are oriented horizontally on the X axis of a coordinate plane. A gravity well is disposed at some C between A and B, such as the gravity well illustrated in FIG. 12. As the user attempts to move the mouse cursor in a substantially horizontal line from A to B, the mouse cursor passes near C. The pull of the gravity well at C can alter the path of the mouse cursor. At any point between A and B, the effect of the gravity well at C can be calculated, for example, by measuring the force generated by each square of the gravity well to determine a net force due to gravity. The net force due to gravity can be added to the intercepted input signals from the input device and used to calculate the position of the mouse cursor.

The force of gravity between the mouse cursor and any particular square can be determined by F=C*M₁*M₂/D², where F is the force between the mouse cursor and a given square, C is a constant that can be set according to user preference for the strength of gravity, M₁ is the “mass” of the cursor, and M₂ is the “mass” of the given square, and D is the distance between them. We say “mass” because the cursor and the given square have no mass in the traditional sense—only a mass assigned to them. The mouse cursor can be assigned a nominal “mass.” The nominal mass of the cursor can be, for example, 5% of the maximum mass of any given square. In the example of FIG. 12, the cursor (not shown) can be assigned a mass of 1. Each square can accumulate mass according to the process described above and, as in FIG. 12, can have a “mass” in the range of 0-5.

At any cursor location, the net force of gravity can be determined by 1.) calculating force vectors between every square and the cursor and then 2.) summing the vectors to get a net gravitational force vector. The net gravitational force vector can be added to the intercepted input signals from the input device (e.g. a mouse). In such an instance, the intercepted input signals can indicate a velocity, for example in pixels/second. Using the same “mass” of the cursor as with the gravity calculations, a force vector for the intended movement of the mouse cursor can be calculated using the equations F=M*V, where M is the “mass” of the cursor and V is the velocity. The cursor force vector and the gravitational force vector can be added together to determine the net effect of gravity on the movement of the mouse cursor. It should be appreciated by those having skill in the art that a vector includes both a magnitude and a direction. Direction can be expressed in degrees or radians from the origin or in simple X and Y coordinates.

In preferred embodiments of the invention, the gravitation effect of gravity wells does not act on the mouse cursor unless the mouse cursor is moving. This prevents the undesirable effect of the mouse cursor accelerating towards a gravity well when a user is not attempting to move the mouse cursor.

In another embodiment the effect of a gravity well on the movement of the mouse cursor can be greatly simplified. Instead of calculating a gravitational effect of a gravity well on the cursor movement, movement speed or mouse sensitivity can be increased when the cursor is moved in the direction of a gravity well. In more detail, if the mouse cursor moves at a default speed ratio of 1 in response to movements on the input device, the movement speed (e.g. movement sensitivity) can be multiplied by a scaling factor when the mouse cursor is moved substantially in the direction of a gravity well. For example, the default speed or sensitivity of the mouse cursor can be increased by a scaling factor of 1.5× when the cursor is moving in the direction of a gravity well and maintain a constant speed or sensitivity when the cursor is not moved in the direction of a gravity well. Any scaling factor can be used to increase the cursor speed or sensitivity in accordance with user preference. The scaling factor can be variable based on the strength of the gravity well. For example, a strong gravity well can increase movement speed of the mouse cursor by a 2× scaling factor while a weak gravity well can increase movement speed of the mouse cursor by a 1.2× scaling factor. The practical result is that a user can reposition the mouse cursor to the location of a gravity well faster than other areas on the display screen thus assisting the user to reposition the mouse cursor to a desired location as quickly as possible.

It will be apparent to those skilled in the art that various modifications and variations can be made in the method for positioning a cursor on a display screen without departing from the spirit or scope of the invention. Thus, it is intended that embodiments of the invention cover the modifications and variations of this invention provided they come within the scope of the appended claims and their equivalents.

What is claimed is:

1. A method for positioning a cursor on a display screen connected to a computer, the method comprising:
dividing the display screen into a logical grid having plurality of sections;
maintaining a value for each of the plurality of sections;
determining an eye-gaze location on the display screen;
determining an eye-gaze duration for the eye-gaze location;
incrementing a first value of a first section of the plurality of sections corresponding to the eye-gaze location after the eye-gaze duration exceeds a first predetermined threshold;
decrementing the first value after a second predetermined threshold;
receiving an input signal from a pointing device, the input signal including an X coordinate and a Y coordinate;
calculating a net force of gravity due to each value of the plurality of sections; and
updating the X coordinate and Y coordinate consistent with the net force of gravity.

2. The method of claim 1 wherein the first predetermined threshold is 100 milliseconds.

3. The method of claim 1 where in the second predetermined threshold is at least two times the first predetermined threshold.

4. The method of claim 1 further comprising:
positioning the cursor at the X coordinate and Y coordinate.

5. The method of claim 1 further comprising:
passing the X coordinate and Y coordinate to an operating system of the computer.

6. The method of claim 1 further comprising:
selecting a mass value of the cursor; and
selecting a gravitational constant.

7. The method of claim 6 wherein the mass value of the cursor is less than five percent of the value of the gravity well.

8. A method for positioning a cursor on a display screen connected to a computer, the method comprising:
determining an eye-gaze location on the display screen;
determining an eye-gaze duration;
increasing a value of a gravity well associated with the eye-gaze location when the eye-gaze duration exceeds a first predetermined duration;
decreasing the value of the gravity well after a second predetermined duration;
receiving a cursor position of the cursor;
calculating a net force of gravity on the cursor due to the gravity well; and
varying a movement speed of the cursor consistent with the calculated net force of gravity.

9. The method of claim 8 wherein the second predetermined duration is at least two times the first predetermined duration.

10. The method of claim 8 further comprising:
selecting a mass value of the cursor; and
selecting a gravitational constant.

11. The method of claim 10 wherein the mass value of the cursor is less than five percent of the value of the gravity well.

12. A method for positioning a cursor on a display screen connected to a computer, the method comprising:
determining an eye-gaze location on the display screen;
determining an eye-gaze duration at the eye-gaze location;
increasing a value of a gravity well associated with the eye-gaze location when the eye-gaze duration exceeds a first predetermined threshold duration;
receiving a cursor position of the cursor;
calculating a net force of gravity due to the gravity well;
varying a movement speed of the cursor consistent with the calculated net force of gravity; and
decreasing the value of the gravity well after a second predetermined threshold duration.

13. The method of claim 12 where the second predetermined threshold duration is at least two times the first predetermined threshold duration.

14. The method of claim 12 further comprising:
determining a mass value of the cursor.

15. The method of claim 12 further comprising:
determining a gravitational constant.

16. A method for positioning a cursor on a display screen connected to a computer, the method comprising:
determining an eye-gaze location on the display screen;
determining an eye-gaze duration at the eye-gaze location;
increasing a value of a gravity well associated with the eye-gaze location when the eye-gaze duration exceeds a first predetermined threshold duration;
receiving a first cursor position of the cursor;
receiving a second cursor position of the cursor;
calculating a movement direction of the cursor;
increasing a movement speed of the cursor when the movement direction is towards the gravity well; and
decreasing the value of the gravity well after a second predetermined threshold duration

17. The method of claim 16 where the second predetermined threshold duration is at least two times the first predetermined threshold duration.

18. The method of claim 16 further comprising:
determining a mass value of the cursor.

19. The method of claim 16 further comprising:
determining a gravitational constant.

20. The method of claim 16 wherein the movement speed is calculated based upon a calculated force of gravity of the gravity well.
